(19) United States
(12) Patent Application Publication
(10) Pub. No.: US 2021/0076654 A1
(43) Pub. Date: Mar. 18, 2021

(54) Insect Trapping Instrument

(71) Applicant: Eric Bjorkgren, Lagrangeville, NY (US)

(72) Inventor: Eric Bjorkgren, Lagrangeville, NY (US)

(21) Appl. No.: 16/568,264

(22) Filed: Sep. 12, 2019

(51) Int. Cl. A01M 1/02; A01M 1/10

(52) U.S. Cl. CPC A01M 1/02; A01M 1/106

(57) ABSTRACT

Systems and methods are disclosed herein for a fly trap assembly specifically designed to trap the insects by using a container having an attractant liquid whom odor attracts the insects to the container. The entry element is provided with concave baffles to enhance the dissemination of attractant odor from the container.

### BACKGROUND

### Field of the Invention

Embodiments relate to a trapping device for trapping insects using the translucent cover of the insect attracting. More particularly, embodiments relate to utilizing a flexible containment means having an attractant therein.

### Description of the Related Art

Present day awareness of the harmful effects of insecticides has generated increasing interest in the use of containment type insect traps.

Blood-sucking insects constitute one of the most significant health issues worldwide, as they spread numerous diseases (for example malaria, yellow fever, dengue, etc.) to both humans and animals and are generally burdensome. Insecticides are used for wide-scale destruction of these pests. A further possibility for controlling and fighting pest insects is the use of traps that are principally intended for small areas, in particular for closed spaces.

Insect traps are known in many types and styles. Simplest is the use of flypaper that is coated with glue so that the insects that contact with it get stuck. Other variants emit ultraviolet light or ultrasound and, in this manner, draw in insect pests. There are also device that use aromatic attractants, for example along with an air stream, so that the attracted insects are sucked by the air stream into a space and held there.

As a method of combating so-called sanitary insect pests such as mosquitoes, other spray insecticides, insect killer and trap are used for controlling insects. Particularly hygienic, spray unfavorable location of pesticides, for example, in the kitchen or food processing factories, it is not possible to spray the insecticide on the normal working hours, insect killer and trap as a means of controlling pests.

There are multiple inventions that have been used in prior art regarding insect killing apparatus. For instance, an insect catching tool bearing Japanese patent 2,002,084957A is issued to Japanese inventor. The patent provides an insect pest catching tool capable of exactly recognizing the breeding of very small insects such as deathwatch beetles, etc., and catching a large amount of the insects. SOLUTION: An insect catching sheet 10 is obtained by forming an adhesive layer 2 on a nonadhesive sheet 1 and the total of the length of the peripheral part of the adhesive layer 2 is longer than that of the peripheral part of the nonadhesive sheet 1.

An Insect trap device and methods of use thereof for the trees bearing Japanese patent 5,0432,40B1 is issued to Japanese inventor. In available outdoors, in all-weather, the effect of easily and was placed in trees insect trapping device able to provide insect instrument and methods of use thereof for trees that can be long period maintained.

The side mount 3 provided continuously through the town 2 on both sides of the left and right sides of the base mount 1, these mount the front surface 1a, as well as applying an adhesive 4,4a on 3a, the front surface 1a of the base mount 1 of placing the spacer member 5 to the adhesive 4, when the when not in use, is unfolded respective side mount 3 on the spacer member 5, when installing the trunk is a side mount 3 open, an adhesive 4,4a surface of the base mount 1 and the side mount 3 is opposed to the tree, base mount 1 and a side positioned on the upper side of the trees the top of the spacer member 5 in a state in contact with the surface of the tree wrapping the ends of the parts mount 3 in the same tree, and be fixed to the tree the winding portion in such adhesive tape.

Another Insect trap bearing Japanese patent 2,006,025634A is issued to Japanese inventor. The patent aims to provide an insect trap which is suitable for trapping small insects (flying insects) flying out from the drain hole of a bathroom, a washroom, and the like at the breeding source and for catching flies, mosquitoes and other flying insects without using an insecticide. <P>SOLUTION: This insect trap is made by disposing an adhesive having an adhesive force in such an extent as capable of trapping insects on the inside of a cup-like main body. The insect trap covers a drain hole to attach or fix hatched insects crept out from the drain hole on the surface of the adhesive. The main body is preferably formed from a transparent of semi-transparent plastic, and the opening of the main body preferably has a size in such an extent as capable of covering at least the whole area of the drain hole.

Another patent on Insect capture device bearing Japanese patent 2,009,296987A is issued to Japanese inventor. The patent aims to provide an insect capture device capable of silently capturing insects without disturbing circumstances around the device and adapted not to reduce insect-capturing efficiency even when a large number of insects are captured. SOLUTION: The insect capture device 1 includes an insect-attracting light source 2 as a first attraction unit for attracting insects 20, a capture unit 3 for capturing the insects 20 attracted by the insect-attracting light source 2, a hair transplanted unit 4 installed at an inlet of the capture unit 3 and slantly transplanted from the inlet toward the inside of the capture unit 3 and an insect-attracting light source 5 as a second attraction unit for attracting the insects 20 attracted by the insect-attracting light source 2 into the capture unit 3 through the hair transplanted unit 4. The insects 20 approaching the insect-attracting light source 2 are attracted by the light emitted from the insect-attracting light source 5 and enter the hair transplanted unit 4. The insects 20 entered the hair-transplanted unit 4 move toward the inside of the capture unit 3 through the hair transplanted unit 4 and are captured by the capture unit 3 after passing through the hair transplanted unit 4. The insects 20 captured by the capture unit 3 die due to lack of baits and water.

Another patent on Insect catching tool bearing Japanese patent 0,799,873A is issued to Japanese inventor. The patent aims to provide an insect catching tool capable of simply seizing flies, cockroaches, mosquitoes and other insects by attaching a tacky air-permeable facial part to the inside of an outer frame with a handle. CONSTITUTION: A tacky air-permeable facial part 4 is attached to the inside of an outer frame 3 with a handle 2 and a non-tacky part 5 is formed at the outside and the upper part of the tacky part. Insect pests can be simply captured by tackiness and an insect catching tool A can be prevented from unnecessarily attaching itself to various parts by the non-tacky part.

There are multiple inventions that have been proposed in prior art regarding insect trapping system. However, the utility of these systems has not been seen in advance form and for specialized needs. The other similar products in the market provide solutions which are obsolete and do not fit for al requirements.

The current invention proposes a system which provides a container having an attractant liquid whom odor attract the insects to the container. The entry element is provided with concave baffles to enhance the dissemination of attractant odor from the container.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of insect trap assembly utilizing a flexible container means having an attractant therein.

It is also the objective of the invention to provide a support which is self-standing and is preferably anchored in place close to the space required.

Another object of the present invention is to provide a fly trap which is highly effective in eradicating insects yet exhibits no detrimental effects upon humans or pets.

It is also the objective of the invention to provide a system which has provision of providing an insect trap that is simple to make and also inexpensive to run and efficient as well.

It is moreover the objective of the invention to provide a system which is easy to install and doesn't requires any special assistance for its operation.

It is further the objective of the invention to provide a reliable system which is effective for almost all types of insects.

It is moreover the objective of the invention to provide a system which is made of high-quality material and insect attractant so not only to provide luxury look and feel, but very effective construction to last.

It is moreover the objective of the invention to provide a system which is of a durable and reliable construction

It is further the objective of the invention to provide an insect trapping assembly which is easy to use, inexpensive and is easy to carry thus is highly portable and provides an advance methodology in similar domain.

It is also the objective of the invention to provide an insect trapping assembly which is highly durable and useable for longer period of time.

An even further object of the present invention is to provide an advance insect trapping assembly which is susceptible of a low cost of manufacture with regard to both materials and labor, and which accordingly is then susceptible of low prices of sale to the consuming public, thereby making such assembly economically available to the buying public.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an insect trapping assembly which provides means for holding a reservoir of liquid attractant. The liquid attractant becomes airborne through the passage of air through the entry element and also provides the medium for ending the life of confined insects after they become exhausted.

The insect trap includes an entry element having a platform which can be used to support a containment bag depending therefrom. The platform contains a central opening and a peripheral region thereabout. A movable access element is located in the opening with the access element including at least two passageways therein. The passageways serve as the entryway for insects and promote the transmission of the airborne attractant from the containment means.

A containment bag depending from the entry element includes three sections. The upper end section is attached to the platform and contains opposing pleats which extend downwardly from the platform and are folded back to the level of the platform. A transition section affixed to the upper section receives the pleats therein. The pleats so formed and secured to the transition section draw the upper section and the transition section into conformance with the peripheral region of the platform. As a result, the upwardly sloping regions or shoulder of bags found in other structures are essentially eliminated from the present invention.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying FIGURES, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1: depicts the fly trap as per preferred embodiment of the invention.

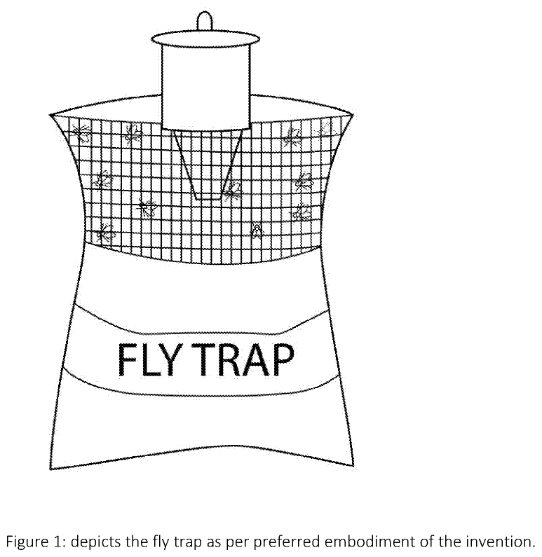

Skilled artisans will appreciate that elements in the figures are illustrated for simplicity and clarity and have not necessarily been drawn to scale. For example, the dimensions of some of the elements in the FIGURES may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

We claim:

I. An insect trap utilizing an aromatic attractant essence comprising:
a containment bag outer shell having an upper closed end and a lower closed end;
a coaxial inner tube having first and second ends, means for attaching said first end to the inside of said closed end of said outer shell said second end of said inner tube extending through said open end of said outer shell;
said inner tube having a plurality of orifices passing through the tube walls, means for closing the second end of said inner tube;
said closing means cooperating with said inner tube so as to confine said essence;
an outer concave baffle linked with said inner tube and spaced from said inner tube;
means on said trap to kill the flies attracted; and
means for inducing a positive draft of air through said orifices within said insect trap;
whereby said positive draft mixes said essence with inducted air creating aromatic air and releases said aromatic air into the atmosphere to attract insects.
